(19) United States
(12) Patent Application Publication
(10) Pub. No.: US 2026/0138089 A1
(43) Pub. Date: May 21, 2026

(54) SPENT CAUSTIC TREATMENT USING AN ELECTROCHEMICAL ROUTE

(71) Applicant: UOP LLC, Des Plaines, IL (US)

(72) Inventors: Saikrishna Gosangari, Haryana (IN); Krishan Pratap Jadaun, Rajasthan (IN); Manshu Kapoor, New Delhi (IN); Ranganadham TPV, Haryana (IN)

(21) Appl. No.: 19/328,705

(22) Filed: Sep. 15, 2025

(30) Foreign Application Priority Data
Nov. 15, 2024 (IN) 202411088422

(51) Int. Cl. B01D 53/96; B01D 53/68; B01D 53/78; C01B 7/01; C25B 1/04; C25B 1/26; C25B 15/08

(52) U.S. Cl. CPC B01D 53/965; B01D 53/68; B01D 53/78; C01B 7/012; C25B 1/04; C25B 1/26; C25B 15/081; B01D 2251/304; B01D 2251/306; B01D 2251/604; B01D 2257/204; B01D 2257/2045; B01D 2258/02

(57) ABSTRACT

Processes for treating spent caustic in a hydrocarbon process utilizing HCl are described. The processes include sending the spent caustic to a caustic scrubbing system. HCl rich off gases are routed to the scrubbing system. This process is designed to deplete the NaOH in the spent caustic and form a brine solution. The brine is sent to an electrochemical cell to convert the NaCl to NaOH while generating chlorine and hydrogen gas. The NaOH generated from the electrochemical reaction is recycled back to the caustic scrubber, while the chlorine and hydrogen gas are combined and recycled back to the reaction zone.

### CROSS-REFERENCES TO RELATED APPLICATIONS

This application claims the benefit of Indian Patent Application number 202411088422 filed on Nov. 15, 2024, the entire disclosure of which is incorporated herein by way of reference.

### BACKGROUND

Perchloroethylene (PERC) has been found to pose an unreasonable risk to human health, and a 10-year phase out has been proposed by the EPA, particularly in the dry-cleaning industry. PERC is also used in other industries including, aviation, petrochemical, refrigeration systems, and its use in these other industries is currently allowed to continue. However, businesses are exploring alternatives to PERC in the event that its use is restricted in the future.

PERC is used as an injection chemical in multiple refinery and petrochemical processes such as isomerization, continuous catalytic reforming, fixed bed reforming, and the like for maintaining catalyst activity. The chlorides generated due to the decomposition of PERC are neutralized using caustic. The spent caustic generated from neutralization is treated in a spent caustic treatment facility. This requires an additional caustic treating facility.

As an example, the current design of some isomerization process units injects PERC based on the combined liquid feed basis into the reactors to maintain the catalyst activity. PERC is continuously injected and combines with hydrogen to form HCl. The HCl formed in the reactors is vented through the downstream stabilizer column. The HCl rich stabilizer off gases are routed to a net gas scrubber where the HCl is neutralized using a caustic solution. Typically, the net gas scrubber is operated as a batch system where 10 wt % to 12 wt % caustic solution is loaded into the net gas scrubber bottoms sump, and the HCl rich gases are bubbled through this caustic solution. The HCl is neutralized with caustic to form NaCl. Once the batch solution strength drops from about 10-12 wt % to typically about 2 wt %, the 2 wt % spent caustic is drained to the caustic degassing drum and sent to the spent caustic treatment facility. The net gas scrubber is replenished with fresh 10-12 wt % caustic solution; this process is typically carried out once every week. The HCl free stabilizer off gases from the net gas scrubber overhead are vented to the fuel gas header. The current processes need continuous fresh caustic intake and spent caustic treatment on a weekly basis, as well as continuous PERC injection. Some customer locations do not have a dedicated caustic treatment facility, which limits the processes which can used there.

### BRIEF DESCRIPTION OF THE DRAWINGS

FIG. 1 is an illustration of one embodiment of a process unit.

FIG. 2 is an illustration of one embodiment of a process according to the present invention.

### DESCRIPTION

This present process is a unique low cost solution directed to eliminating continuous or intermittent PERC injection to the reaction zone and caustic consumption in the net gas scrubber in any process technologies where HCl/KCl liberated is treated with caustic. The proposed solution achieves this by integrating an electrochemical chlor-alkali process with a process such as isomerization, reforming, and the like. It eliminates continuous PERC addition, caustic consumption, and the need for spent caustic disposal. It also provides a solution for customers who do not have dedicated spent caustic treatment facilities. For example, within isomerization technology, either a chlorided alumina or non chlorided alumina based catalyst can be utilized. However, customers who do not have a dedicated caustic treatment facility are forced to adopt non chlorided based isomerization technologies. With this solution, customers can adopt either of the isomerization solutions based on economics rather than system limitations.

The process utilizes the chlor-alkali procedure to manage the caustic requirement in a refinery. Based on process specifics, the electrochemical reactions are carried out in a stack that macroscopically has an anode catalyst, cathode catalyst, and a selectively ion-conducting membrane. At the anode, the feed should be substantially free from any caustic to avoid an oxygen evolution reaction. Therefore, the spent caustic stream is introduced to a caustic scrubber system, where the caustic content in the stream is eliminated. After scrubbing, the stream is introduced to the anode compartment of the stack (referred to as concentrated brine), where, the chlorine is formed by electrochemical reaction, resulting in a brine depleted stream. The brine depleted stream from the anode is a feed to the cathode compartment.

The cathode catalyst requires about 1-5% concentration of caustic to drive the desired electrochemical reaction thermodynamically in a forward direction. Therefore, caustic is added to the brine depleted stream from the anode (a slip stream recycle from the caustic stream from the cathode). After the addition of the caustic, the brine depleted stream is sent to the cathode wherein along with hydrogen evolution reaction, the caustic is concentrated and recycled to the remaining process.

The scrubber can be a single stage or a multistage unit. The stages may be contained in one or more vessels.

In some embodiments, the spent caustic from the net gas scrubber is treated in a pre-caustic scrubber to fully neutralize the caustic before routing the brine to the electrochemical cell.

In the electrochemical cell, the saturated brine is passed into the anode chamber. Due to the higher concentration of chloride ions in the brine, the chloride ions are oxidized at the anode, losing electrons to become chlorine gas:

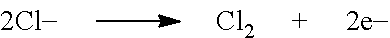

At the cathode, positive hydrogen ions pulled from water molecules are reduced by the electrons provided by the electrolytic current to hydrogen gas, releasing hydroxide ions into the solution:

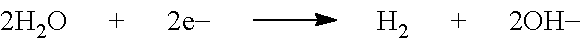

The ion-permeable ion-exchange membrane at the center of the cell allows only the sodium ions (Na+) to pass from the anode chamber to the cathode chamber where they react with the hydroxide ions to produce caustic soda (NaOH):

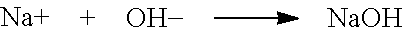

The overall reaction for the electrolysis of brine is thus:

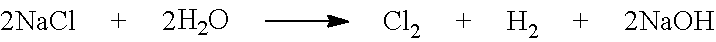

A common electrolyzer cell could be integrated to meet the chloride requirements of an isomerization unit, a catalytic reforming unit, a catalytic dehydrogenation unit, an alkylation unit, and/or any other process which utilizes HCl/Cl₂.

The process can be implemented as a modular package for existing processes or integrated in new process designs.

The process provides potential capital and operating cost benefits due to the elimination of PERC, caustic injection, and spent caustic treatment requirements while not impacting process performance. In some processes, PERC injection drums and PERC injection and transfer pumps can be eliminated, and fresh caustic makeup and spent caustic generation are eliminated. In some processes, hydrogen consumption is reduced. In some processes, anhydrous HCl cylinders are eliminated. In some processes, water consumption for dilution of caustic is reduced. Hazardous chemical inventory management is reduced or eliminated.

In existing processes, the spent caustic (with a typical composition of 10.7 wt % NaCl, 2 wt % NaOH, 87.3 wt % H₂O, for example) from the net gas scrubber in the isomerization process unit is typically routed to a spent caustic treatment facility.

In contrast, in one embodiment of the present process, the scrubber includes a net gas scrubber and a pre-caustic scrubber. The spent caustic is routed to a pre-caustic scrubbing system. The HCl rich stabilizer off gases are routed to the pre-caustic scrubbing system and from there to the net gas scrubber. This process is designed to deplete the 2-15 wt % NaOH in the spent caustic and form a brine solution comprising NaCl (5-30 wt %) and water (70-95 wt %). The brine is sent to an electrochemical cell supplied with either renewable power generated using renewable resources such as wind or solar or hydro or a combination of all and/or grey power generated using refinery fuel gas, natural gas, fuel oil or a combination of all to convert the NaCl back to NaOH while generating chlorine and hydrogen gas. The NaOH generated from this electrochemical reaction is recycled back to the net gas caustic scrubber, while the chlorine and hydrogen gas are combined and recycled back to the reactor section for HCl generation. This system allows regeneration of the caustic and eliminates the need for sending spent caustic to the treatment facility, as well as the weekly or continuous fresh caustic injection from battery limit. Generation of Cl₂ and H₂ allows reutilization of the chlorides within the system and eliminates continuous PERC consumption.

In other embodiments, the spent caustic has been fully neutralized as it exits the scrubber unit which has one or more beds in a single vessel.

One aspect of the invention is a process for treating spent caustic in a hydrocarbon process utilizing HCl. In one embodiment, the process comprises: passing an off gas stream comprising HCl from a reaction zone to a caustic scrubber; contacting th e off gas stream with a caustic stream in the caustic scrubber, the caustic stream comprising NaOH, or KOH, or both, and neutralizing the NaOH, or the KOH, or both forming a brine stream substantially free of the NaOH and the KOH and an overhead stream substantially free of the HCl, or the KCl, or both; passing the brine stream through an electrochemical cell forming a chlorine gas stream, a hydrogen gas stream, and the caustic stream comprising the NaOH, or the KOH, or both and an amount of NaCl, or KCl, or both less than an amount of NaCl, or KCl, or both in the brine stream; and passing the hydrogen gas stream and the chlorine gas stream to the reaction zone.

In some embodiments, passing the brine stream through the electrochemical cell comprises: passing the brine stream to an anode of the electrochemical cell forming the chlorine gas stream and a depleted brine stream having an amount of NaCl, or KCl, or both less than the amount of NaCl, or KCl, or both in the brine stream; and passing the depleted brine stream to the cathode of the electrochemical cell forming the hydrogen gas stream and the caustic stream.

In some embodiments, the process further comprises: mixing a portion of the caustic stream with the depleted brine stream before passing the depleted brine stream to the cathode of the electrochemical cell.

In some embodiments, the caustic stream comprises less than or equal to 10 wt % NaCl, or KCl, or both.

In some embodiments, the process further comprises: adding a fresh brine makeup stream to the brine stream.

In some embodiments, the fresh brine makeup stream comprises greater than 8 wt % NaCl, or KCl, or both, or greater than 10 wt %, or greater than 15 wt %.

In some embodiments, the process further comprises: compressing and drying the hydrogen gas stream and the chlorine gas stream before passing the hydrogen gas stream and the chlorine gas stream to the reaction zone.

In some embodiments, the process further comprises: removing water from the hydrogen gas stream and the chlorine gas stream before passing the hydrogen gas stream and the chlorine gas stream to the reaction zone.

In some embodiments, the process further comprises: mixing the water with the brine stream before passing the brine stream through the electrochemical cell.

In some embodiments, the process further comprises: reacting the hydrogen gas with the chlorine gas to form HCl, or KCl, or both and wherein passing the hydrogen gas stream and the chlorine gas stream to the reaction zone comprises passing the HCL to the reaction zone.

In some embodiments, the caustic stream comprises 2 wt % to 50 wt % of the NaOH, or the KOH, or both. In some embodiments, the caustic stream comprises 10 wt % to 20 wt % of the NaOH, or the KOH, or both

In some embodiments, the brine stream comprises less than or equal to 1 wt % NaOH, or KOH, or both.

In some embodiments, the depleted brine stream comprises less than or equal to 10 wt % NaCl, or KCl, or both.

In some embodiments, the reaction zone comprises an isomerization reaction zone, a reforming reaction zone, a dehydrogenation reaction zone, a catalytic dehydrogenation reaction zone, an alkylation reaction zone, an oil or gas refining process using perchloroethylene and caustic, or combinations thereof.

Another aspect of the invention is a process for treating spent caustic in a hydrocarbon process utilizing HCl, or KCl, or both. In one embodiment, the process comprises: passing an off gas stream comprising HCl, or KCl, or both from a reaction zone to a caustic scrubber comprising one or more reaction beds; contacting the off gas stream with a caustic stream in the caustic scrubber, the caustic stream comprising 2 wt % to 50 wt % NaOH, or KOH, or both and neutralizing the NaOH, or KOH, or both forming a brine stream comprising less than or equal to 1 wt % NaOH, or KOH, or both, and an overhead stream substantially free of the HCl, or KCl, or both; passing the brine stream through an electrochemical cell forming a chlorine gas stream, a hydrogen gas stream, and the caustic stream comprising the NaOH, or the KOH, or both and an amount of NaCl or KCl or both less than an amount of NaCl or KCl or both in the brine stream; and passing the hydrogen gas stream and the chlorine gas stream to the reaction zone.

In some embodiments, passing the brine stream through the electrochemical cell comprises: passing the brine stream to an anode of the electrochemical cell forming the chlorine gas stream and a depleted brine stream having an amount of NaCl, or KCl, or both less than the amount of NaCl, or KCl, or both in the brine stream; and passing the depleted brine stream to the cathode of the electrochemical cell forming the hydrogen gas stream and the caustic stream.

In some embodiments, the process further comprises: mixing a portion of the caustic stream with the depleted brine stream before passing the depleted brine stream to the cathode of the electrochemical cell.

In some embodiments, the process further comprises: compressing and drying the hydrogen gas stream and the chlorine gas stream before passing the hydrogen gas stream and the chlorine gas stream to the reaction zone.

In some embodiments, the reaction zone comprises an isomerization reaction zone, a reforming reaction zone, a dehydrogenation reaction zone, a catalytic dehydrogenation reaction zone, an alkylation reaction zone, an oil or gas refining process using perchloroethylene and caustic, or combinations thereof.

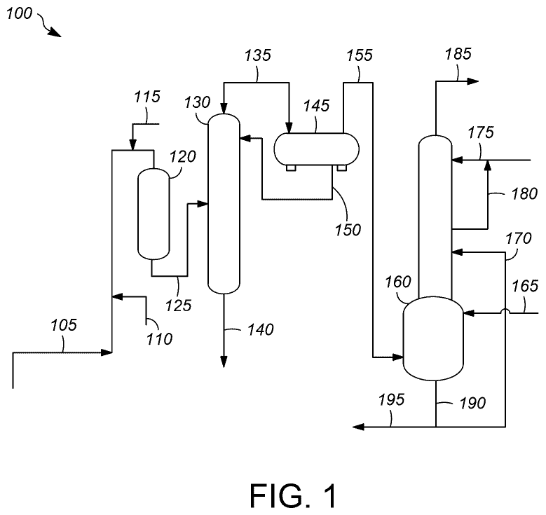

FIG. 1 illustrates a typical catalytic isomerization process 100. The light naphtha feed stream 105 comprising C₄-C₇ paraffins for example, hydrogen stream 110, and PERC stream 115 are sent to isomerization reactor 120.

The isomerization reactor effluent stream 125 is sent to stabilizer column 130 where it is separated into stabilizer overhead stream 135 comprising hydrogen, HCl and C₁-C₄ paraffins and stabilizer bottom stream 140 comprising C₄-C₇ paraffins.

The stabilizer overhead stream 135 is sent to stabilizer overhead receiver 145 where it is separated into stabilizer receiver liquid stream 150 and stabilizer receiver off gas stream 155. The stabilizer receiver liquid stream 150 is refluxed to the stabilizer column 130.

The stabilizer receiver off gas stream 155 is sent to caustic scrubber 160. Fresh caustic stream 165 containing 10 wt % to 12 wt % NaOH and recycle caustic stream 170 containing about 2-12 wt % NaOH enter the caustic scrubber 160 and contact the stabilizer overhead vapor stream in the caustic scrubber 160. Water stream 175 and water recycle stream 180 are introduced into the caustic scrubber 160 above the point at which the fresh caustic stream and the recycle caustic stream 170 enter.

The caustic scrubber off gas stream 185 is sent to the fuel gas header (not shown). The spent caustic stream 190 which contains about 2 wt % NaOH exits the bottom of the caustic scrubber 160. The spent caustic stream 190 is divided into recycle caustic stream 170 and spent caustic stream 195. Spent caustic stream 195 is degassed and sent to a spent caustic treatment facility (not shown).

The stabilizer bottom stream 140 named as liquid product or isomerate is sent to the product storage facility (not shown)

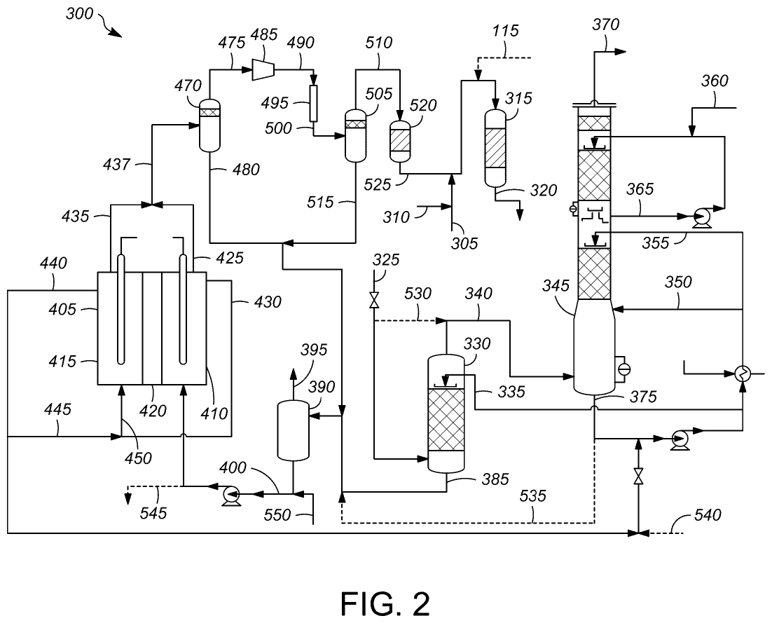

FIG. 2 illustrates one embodiment of the process 300 for treating spent caustic in the catalytic isomerization process 100 of FIG. 1. Only a portion of the catalytic isomerization process 100 of FIG. 1 is shown in FIG. 2. The stabilizer column and stabilizer receiver have been omitted.

The light naphtha feed stream 305, and hydrogen stream 310 are sent to isomerization reactor 315. PERC stream 115 has been eliminated.

The isomerization effluent stream 320 is sent to a stabilizer column (not shown) where it is separated into stabilizer overhead stream and stabilizer bottom stream. The stabilizer overhead stream is sent to stabilizer receiver (not shown) where it is separated into stabilizer overhead liquid stream and stabilizer overhead vapor stream. The stabilizer overhead liquid stream is refluxed to the stabilizer column.

The stabilizer receiver off gas stream 325 comprising HCl (1000-5000 wppm) is sent to a pre-caustic scrubber 330 where it is contacted with caustic stream 335. Caustic stream 335 may contain 2-15 wt % NaCl, about 2-12 wt % NaOH, with the remainder being water. The NaOH in the spent caustic stream 335 is neutralized by the HCl in the stabilizer receiver off gas stream 325. All, or substantially all, of the NaOH from the spent caustic stream 335 is neutralized in the pre-caustic scrubber 330.

The pre-caustic scrubber overhead vapor stream 340 comprising any remaining HCl is sent to the caustic scrubber 345 where it is contacted with caustic streams 350 and 355 and water stream 360 and recycle water stream 365.

The caustic scrubber off gas stream 370 comprising hydrogen, and C₁-C₄ paraffins is sent to the fuel gas header (not shown). The spent caustic stream 375 which contains about 2-12 wt % NaOH exits the bottom of the caustic scrubber 345. The spent caustic stream 375 is divided into recycle caustic stream 350 and spent caustic stream 335.

The brine stream 385 from the pre-caustic scrubber 330 comprises 12 wt % to 15 wt % NaCl with the remainder being water and is substantially NaOH-free. The brine stream typically comprises less than or equal to 1 wt % NaOH. The brine stream 385 desirably contains no NaOH.

Brine stream 385 is sent to an optional degassing drum 390 to remove any dissolved gases in the brine (typically none are present). The degassed vapor stream 395 if present is sent to a flare header (not shown). Spent Caustic stream 545 has been eliminated.

The degassed brine stream 400 is sent to an electrochemical cell 405 comprising an anode chamber 410 and a cathode chamber 415 separated by an ion-permeable ion-exchange membrane 420.

The degassed brine stream 400 enters the anode chamber 410 where the chloride ions are oxidized and form chlorine gas stream 425. The depleted brine stream 430 comprising less than 1 wt % NaCl with the remainder being water is sent to the cathode chamber 415 where the water molecules are reduced forming hydrogen gas stream 435 and hydroxide ions. The Na ions from the anode chamber 410 pass through the ion-permeable ion-exchange membrane 420 and react with the hydroxide ions from the cathode chamber to form NaOH.

The concentrated NaOH stream 440 from the cathode chamber 415, which comprises less than or equal to 10 wt % NaCl, 10 wt % to 30 wt % NaOH, with the remainder being water, is recycled back to the caustic scrubber 345. Fresh caustic stream 540 has been eliminated.

A slip stream 445 of the concentrated NaOH stream 440 is mixed with the depleted brine stream 430 from the anode chamber 410 to form a mixed stream 450 comprising 5 wt % to 30 wt % NaCl, 1 wt % to 5 wt % NaOH, with the remainder being water. The mixed stream 450 is sent to the cathode chamber 415.

A fresh brine stream 550 comprising 8 wt % to 30 wt % NaCl can be optionally added to the inlet of the degassing drum at the start of the unit operation.

The chlorine gas stream 425 and hydrogen gas stream 435 are combined forming combined gas stream 437. The combined gas stream 437 is sent to a suction knock-out drum 470 where it is separated into a first dewatered gas stream 475 and a first water stream 480. The first dewatered gas stream 475 is compressed in gas compressor 485 forming a compressed gas stream 490. There can be one or more compressors.

Compressed gas stream 490 is cooled in cooler 495, and the cooled gas stream 500 is sent to a discharge knock out drum 505 where is it separated into a second dewatered gas stream 510 and a second water stream 515.

The second dewatered gas stream 510 is sent to a dryer 520 forming dried gas stream 525. There can be one or more dryers.

The dried gas stream 525 is combined with the light naphtha feed stream 305 and the hydrogen stream 310 and sent to the isomerization reactor 320.

Bypass lines 530 and 535 allow the pre-caustic scrubber and the electrochemical cell to be bypassed, if needed. The stabilizer receiver off gas stream 325 can be sent through bypass line 530 to the caustic scrubber 345, and the spent caustic stream 375 can be sent through bypass line 535 to the degassing drum 390.

### Specific Embodiments

While the following is described in conjunction with specific embodiments, it will be understood that this description is intended to illustrate and not limit the scope of the preceding description and the appended claims.

A first embodiment of the invention is a process for treating spent caustic in a hydrocarbon process utilizing HCl comprising passing an off gas stream comprising HCl from a reaction zone to a caustic scrubber; contacting the off gas stream with a caustic stream in the caustic scrubber, the caustic stream comprising NaOH, or KOH, or both, and neutralizing the NaOH, or KOH, or both forming a brine stream substantially free of the NaOH and the KOH and an overhead stream substantially free of the HCl; passing the brine stream through an electrochemical cell forming a chlorine gas stream, a hydrogen gas stream, and the caustic stream comprising the NaOH, or the KOH, or both and an amount of NaCl or KCl or both less than an amount of NaCl or KCl or both in the brine stream; and passing the hydrogen gas stream and the chlorine gas stream to the reaction zone. An embodiment of the invention is one, any or all of prior embodiments in this paragraph up through the first embodiment in this paragraph wherein passing the brine stream through the electrochemical cell comprises passing the brine stream to an anode of the electrochemical cell forming the chlorine gas stream and a depleted brine stream having an amount of NaCl, or KCl, or both less than the amount of NaCl, or KCl, or both in the brine stream; passing the depleted brine stream to the cathode of the electrochemical cell forming the hydrogen gas stream and the caustic stream. An embodiment of the invention is one, any or all of prior embodiments in this paragraph up through the first embodiment in this paragraph further comprising mixing a portion of the caustic stream with the depleted brine stream before passing the depleted brine stream to the cathode of the electrochemical cell. An embodiment of the invention is one, any or all of prior embodiments in this paragraph up through the first embodiment in this paragraph wherein the caustic stream comprises less than or equal to 10 wt % NaCl, or KCl, or both. An embodiment of the invention is one, any or all of prior embodiments in this paragraph up through the first embodiment in this paragraph further comprising adding a fresh brine makeup stream to the brine stream. An embodiment of the invention is one, any or all of prior embodiments in this paragraph up through the first embodiment in this paragraph wherein the fresh brine makeup stream comprises greater than 8 wt % NaCl, or KCl, or both. An embodiment of the invention is one, any or all of prior embodiments in this paragraph up through the first embodiment in this paragraph further comprising compressing and drying the hydrogen gas stream and the chlorine gas stream before passing the hydrogen gas stream and the chlorine gas stream to the reaction zone. An embodiment of the invention is one, any or all of prior embodiments in this paragraph up through the first embodiment in this paragraph further comprising removing water from the hydrogen gas stream and the chlorine gas stream before passing the hydrogen gas stream and the chlorine gas stream to the reaction zone. An embodiment of the invention is one, any or all of prior embodiments in this paragraph up through the first embodiment in this paragraph further comprising mixing the water with the brine stream before passing the brine stream through the electrochemical cell. An embodiment of the invention is one, any or all of prior embodiments in this paragraph up through the first embodiment in this paragraph further comprising reacting the hydrogen gas with the chlorine gas to form HCl and wherein passing the hydrogen gas stream and the chlorine gas stream to the reaction zone comprises passing the HCL to the reaction zone. An embodiment of the invention is one, any or all of prior embodiments in this paragraph up through the first embodiment in this paragraph wherein the caustic stream comprises 2 wt % to 50 wt % of the NaOH, or the KOH, or both. An embodiment of the invention is one, any or all of prior embodiments in this paragraph up through the first embodiment in this paragraph wherein the brine stream comprises less than or equal to 1 wt % NaOH, or KOH, or both. An embodiment of the invention is one, any or all of prior embodiments in this paragraph up through the first embodiment in this paragraph wherein the depleted brine stream comprises less than or equal to 10 wt % NaCl, or KCl, or both. An embodiment of the invention is one, any or all of prior embodiments in this paragraph up through the first embodiment in this paragraph wherein the reaction zone comprises an isomerization reaction zone, a reforming reaction zone, a dehydrogenation reaction zone, a catalytic dehydrogenation reaction zone, an alkylation reaction zone, an oil or gas refining process using perchloroethylene and caustic, or combinations thereof.

A second embodiment of the invention is a process for treating spent caustic in a hydrocarbon process utilizing HCl comprising passing an off gas stream comprising HCl from a reaction zone to a caustic scrubber comprising one or more reaction beds; contacting the off gas stream with a caustic stream in the caustic scrubber, the caustic stream comprising 2 wt % to 50 wt % NaOH, or KOH, or both and neutralizing the NaOH, or KOH, or both forming a brine stream comprising less than or equal to 1 wt % NaOH, or KOH, or both, and an overhead stream substantially free of the HCl; passing the brine stream through an electrochemical cell forming a chlorine gas stream, a hydrogen gas stream, and the caustic stream comprising the NaOH, or the KOH, or both and an amount of NaCl or KCl or both less than an amount of NaCl or KCl or both in the brine stream; and passing the hydrogen gas stream and the chlorine gas stream to the reaction zone. An embodiment of the invention is one, any or all of prior embodiments in this paragraph up through the second embodiment in this paragraph wherein passing the brine stream through the electrochemical cell comprises passing the brine stream to an anode of the electrochemical cell forming the chlorine gas stream and a depleted brine stream having an amount of NaCl, or KCl, or both less than the amount of NaCl, or KCl, or both in the brine stream; passing the depleted brine stream to the cathode of the electrochemical cell forming the hydrogen gas stream and the caustic stream. An embodiment of the invention is one, any or all of prior embodiments in this paragraph up through the second embodiment in this paragraph further comprising mixing a portion of the caustic stream with the depleted brine stream before passing the depleted brine stream to the cathode of the electrochemical cell. An embodiment of the invention is one, any or all of prior embodiments in this paragraph up through the second embodiment in this paragraph further comprising compressing and drying the hydrogen gas stream and the chlorine gas stream before passing the hydrogen gas stream and the chlorine gas stream to the reaction zone. An embodiment of the invention is one, any or all of prior embodiments in this paragraph up through the second embodiment in this paragraph wherein the reaction zone comprises an isomerization reaction zone, a reforming reaction zone, a dehydrogenation reaction zone, a catalytic dehydrogenation reaction zone, an alkylation reaction zone, an oil or gas refining process using perchloroethylene and caustic, or combinations thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for treating spent caustic in a hydrocarbon process utilizing HCl comprising:
passing an off gas stream comprising HCl, or KCl, or both from a reaction zone to a caustic scrubber;
contacting the off gas stream with a caustic stream in the caustic scrubber, the caustic stream comprising NaOH, or KOH, or both, and neutralizing the NaOH, or the KOH, or both forming a brine stream substantially free of the NaOH and the KOH and an overhead stream substantially free of the HCl, KCl, or both;
passing the brine stream through an electrochemical cell forming a chlorine gas stream, a hydrogen gas stream, and the caustic stream comprising the NaOH, or the KOH, or both and an amount of NaCl or KCl or both less than an amount of NaCl, or KCl, or both in the brine stream; and
passing the hydrogen gas stream and the chlorine gas stream to the reaction zone.

2. The process of claim 1 wherein passing the brine stream through the electrochemical cell comprises:
passing the brine stream to an anode of the electrochemical cell forming the chlorine gas stream and a depleted brine stream having an amount of NaCl, or KCl, or both less than the amount of NaCl, or KCl, or both in the brine stream; and
passing the depleted brine stream to the cathode of the electrochemical cell forming the hydrogen gas stream and the caustic stream.

3. The process of claim 2 further comprising:
mixing a portion of the caustic stream with the depleted brine stream before passing the depleted brine stream to the cathode of the electrochemical cell.

4. The process of claim 1 wherein the caustic stream comprises less than or equal to 10 wt % NaCl, or KCl, or both.

5. The process of claim 1 further comprising:
adding a fresh brine makeup stream to the brine stream.

6. The process of claim 5 wherein the fresh brine makeup stream comprises greater than 8 wt % NaCl, or KCl, or both.

7. The process of claim 1 further comprising:
compressing and drying the hydrogen gas stream and the chlorine gas stream before passing the hydrogen gas stream and the chlorine gas stream to the reaction zone.

8. The process of claim 1 further comprising:
removing water from the hydrogen gas stream and the chlorine gas stream before passing the hydrogen gas stream and the chlorine gas stream to the reaction zone.

9. The process of claim 8 further comprising:
mixing the water with the brine stream before passing the brine stream through the electrochemical cell.

10. The process of claim 1 further comprising
reacting the hydrogen gas with the chlorine gas to form HCl and wherein passing the hydrogen gas stream and the chlorine gas stream to the reaction zone comprises passing the HCL to the reaction zone.

11. The process of claim 1 wherein the caustic stream comprises 2 wt % to 50 wt % of the NaOH, or the KOH, or both.

12. The process of claim 1 wherein the brine stream comprises less than or equal to 1 wt % NaOH, or KOH, or both.

13. The process of claim 1 wherein the depleted brine stream comprises less than or equal to 10 wt % NaCl, or KCl, or both.

14. The process of claim 1 wherein the reaction zone comprises an isomerization reaction zone, a reforming reaction zone, a dehydrogenation reaction zone, a catalytic dehydrogenation reaction zone, an alkylation reaction zone, an oil or gas refining process using perchloroethylene and caustic, or combinations thereof.

15. A process for treating spent caustic in a hydrocarbon process utilizing HCl comprising:
passing an off gas stream comprising HCl from a reaction zone to a caustic scrubber comprising one or more reaction beds;
contacting the off gas stream with a caustic stream in the caustic scrubber, the caustic stream comprising 2 wt % to 50 wt % NaOH, or KOH, or both and neutralizing the NaOH, or KOH, or both forming a brine stream comprising less than or equal to 1 wt % NaOH, or KOH, or both, and an overhead stream substantially free of the HCl;
passing the brine stream through an electrochemical cell forming a chlorine gas stream, a hydrogen gas stream, and the caustic stream comprising the NaOH, or the KOH, or both and an amount of NaCl or KCl or both less than an amount of NaCl or KCl or both in the brine stream; and
passing the hydrogen gas stream and the chlorine gas stream to the reaction zone.

16. The process of claim 15 wherein passing the brine stream through the electrochemical cell comprises:
passing the brine stream to an anode of the electrochemical cell forming the chlorine gas stream and a depleted brine stream having an amount of NaCl, or KCl, or both less than the amount of NaCl, or KCl, or both in the brine stream; and
passing the depleted brine stream to the cathode of the electrochemical cell forming the hydrogen gas stream and the caustic stream.

17. The process of claim 16 further comprising:
mixing a portion of the caustic stream with the depleted brine stream before passing the depleted brine stream to the cathode of the electrochemical cell.

18. The process of claim 15 further comprising:
compressing and drying the hydrogen gas stream and the chlorine gas stream before passing the hydrogen gas stream and the chlorine gas stream to the reaction zone.

19. The process of claim 15 wherein the reaction zone comprises an isomerization reaction zone, a reforming reaction zone, a dehydrogenation reaction zone, a catalytic dehydrogenation reaction zone, an alkylation reaction zone, an oil or gas refining process using perchloroethylene and caustic, or combinations thereof.
